(19) United States
(12) Patent Application Publication
(10) Pub. No.: US 2024/0419882 A1
(43) Pub. Date: Dec. 19, 2024

(54) SELECTIVE CUTS TO REMOVE PREDICTED INTERCONNECT BULGING REGIONS

(71) Applicant: International Business Machines Corporation, Armonk, NY (US)

(72) Inventors: Xiaoming Yang, Clifton Park, NY (US); SOMNATH GHOSH, Clifton Park, NY (US); Huai Huang, Clifton Park, NY (US); Yann Mignot, Slingerlands, NY (US); Kai Zhao, Albany, NY (US); Daniel Charles Edelstein, White Plains, NY (US)

(21) Appl. No.: 18/333,685

(22) Filed: Jun. 13, 2023

(51) Int. Cl. G06F 30/39

(52) U.S. Cl. CPC G06F 30/39; G06F 2119/18

(57) ABSTRACT

Embodiments of the invention are directed to a computer system having a processor communicatively coupled to a memory. The processor performs processor operations that include accessing an electronic file that includes an electronic integrated circuit (IC) design. The electronic file is operable to control a fabrication system to fabricate an IC according to the electronic IC design. The processor operations further includes applying a bulging predication analysis to the electronic IC design; and making one or more changes to the electronic IC design based at least in part on a result of the bulging prediction analysis.

### BACKGROUND

The present invention relates in general to programmable computers that use computer-aided-design (CAD) systems to control the design and fabrication of integrated circuits (ICs). More specifically, the present invention relates to programmable computer systems, computer-implemented methods, and computer program products operable to predict bulging that will occur in as-fabricated interconnect structures of an IC design and update an associated CAD file to add selective cuts that remove the predicted bulging portion(s) of the interconnect structure.

Computer-aided design (CAD) is the use of computer-based software to aid in design processes. CAD software can be used to create two-dimensional (2-D) drawings or three-dimensional (3-D) models of a device-under-design (DUD). CAD software generally includes a variety of tools that enable a designer to optimize and streamline workflow; increase productivity; improve the quality and level of detail in the design; improve documentation communications; and often contribute toward a manufacturing design database. CAD software outputs come in the form of electronic files, which can be used in tandem with computer-aided manufacturing (CAM) software to control manufacturing and/or fabrication processes. CAD/CAM is software routinely used to design products such as electronic circuit boards in computers and other devices.

CAD/CAM software can be used to generate the IC layout that places and connects all of the components that make up each IC chip such that it meets certain criteria, including, for example, performance, size, density, and manufacturability. IC fabrication processes include the use of patterned masks to define and form the various devices (e.g., transistors) and structures (e.g., interconnect lines/vias) of the IC. The generated layout must pass a series of checks in a process known as physical verification. When all verification is complete, layout post processing is applied where the IC layout is translated into data (e.g., an industry-standard format, typically GDSII) and sent to a semiconductor foundry. The foundry converts the data into mask data and uses it to generate the masks used in a photolithographic process of semiconductor device fabrication.

### SUMMARY

Embodiments of the invention are directed to a computer system having a processor communicatively coupled to a memory. The processor performs processor operations that include accessing an electronic file that includes an electronic integrated circuit (IC) design. The electronic file is operable to control a fabrication system to fabricate an IC according to the electronic IC design. The processor operations further includes applying a bulging predication analysis to the electronic IC design; and making one or more changes to the electronic IC design based at least in part on a result of the bulging prediction analysis.

Embodiments of the invention are also directed to a computer program product that includes a computer readable program stored on a computer readable storage medium, where the computer readable program, when executed on a processor system, causes the processor system to perform processor operations. The processor operations include accessing an electronic file that includes an electronic IC design. The electronic file is operable to control a fabrication system to fabricate an IC according to the electronic IC design. The processor operations further includes applying a bulging predication analysis to the electronic IC design; and making one or more changes to the electronic IC design based at least in part on a result of the bulging prediction analysis.

Embodiments of the invention are also directed to computer-implemented methods having substantially the same features as the computer system and computer program product described above.

Embodiments of the invention are also directed to a multi-layer IC that includes a network of interconnect structures that include one or more end-cut interconnect structures and one or more non-end-cut interconnect structures. A bulging predictor condition (BPC) associated with each of the one or more end-cut interconnect structures is within a predetermined end-cut BPC range.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment operable to implement aspects of the invention;

FIG. 2 depicts a simplified block diagram illustrating a semiconductor fabrication system operable to implement aspects of the invention;

FIG. 3 depicts a flow diagram illustrating a computer-implemented methodology according to embodiments of the invention;

FIG. 4 depicts a portion of an IC wafer that illustrates the concept of interconnect pattern density (IPD), which is utilized in aspects of the invention;

FIG. 5A depicts a simplified block diagram illustrating a top-down view of as-designed interconnect structures that are being evaluated to predict whether or not the interconnect structures will experience end-region bulging during fabrication in accordance with embodiments of the invention;

FIG. 5B depicts a simplified block diagram illustrating a top-down view of as-designed interconnect structures that are being evaluated to predict whether or not the interconnect structures will experience end-region bulging during fabrication in accordance with embodiments of the invention;

FIG. 5C depicts a simplified block diagram illustrating a top-down view of an as-fabricated interconnect structure that has classified as needing a selective cut in accordance with aspects of the invention, along with another top-down view of the as-fabricated interconnect structure after the selective cuts have been performed in accordance with embodiments of the invention;

FIGS. 6A-6E depict cross-sectional views and/or top-down views illustrating a portion of a multi-layer IC after self-aligned litho-etch litho-etch (SALELE) fabrication operations in accordance with aspects of the invention, in which:

FIG. 6A depicts cross-sectional views of the portion of the multi-layer IC after fabrication operations according to aspects of the invention;

FIG. 6B depicts top-down views of the portion of the multi-layer IC after fabrication operations according to aspects of the invention;

FIG. 6C depicts a cross-sectional view and a top-down view of the portion of the multi-layer IC after fabrication operations according to aspects of the invention;

FIG. 6D depicts cross-sectional views of the portion of the multi-layer IC after a fabrication operations according to aspects of the invention; and

FIG. 6E depicts cross-sectional views of the portion of the multi-layer IC after fabrication operations according to aspects of the invention; and

FIG. 7 depicts a top-down view of a portion of a multi-layer IC illustrating an incorrect cut region and a correct cut-region according to aspects of the invention.

In the accompanying figures and following detailed description of the disclosed embodiments, the various elements illustrated in the figures are provided with three digit reference numbers. In some instances, the leftmost digits of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Similarly, conventional techniques related to semiconductor device and integrated circuit (IC) fabrication may or may not be described in detail herein. Moreover, the various tasks and process steps described herein can be incorporated into a more comprehensive procedure or process having additional steps or functionality not described in detail herein. In particular, various steps in the manufacture of semiconductor devices and semiconductor-based ICs are well known and so, in the interest of brevity, many conventional steps will only be mentioned briefly herein or will be omitted entirely without providing the well-known process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

Turning now to an overview of technologies that are more specifically relevant to aspects of the invention, ICs are typically formed from various circuit configurations of semiconductor devices (e.g., transistors, capacitors, resistors, etc.) and conductive interconnect layers (known as metallization layers) formed on semiconductor wafers. Alternatively, semiconductor devices can be formed as monolithic devices, e.g., discrete devices. ICs, discrete semiconductor devices, and conductive interconnect layers are formed on semiconductor wafers by depositing many types of thin films of material over the semiconductor wafers, patterning the thin films, doping selective regions of the semiconductor wafers, etc.

In contemporary semiconductor fabrication processes, a large number of semiconductor devices and conductive interconnect layers are fabricated. More specifically, during the first portion of chip-making (i.e., the front-end-of-line (FEOL) stage), the individual components (transistors, capacitors, etc.) are fabricated on the wafer. The middle-of-line (MOL) stage follows the FEOL stage and typically includes process flows for forming the contacts and other structures that communicatively couple to active regions (e.g., gate, source, and drain) of the device element. In the back-end-of-line (BEOL) stage, these device elements are connected to each other through a network of interconnect structures to distribute signals, as well as power and ground. The conductive interconnect layers formed during the BEOL stage serve as a network of pathways that transport signals throughout an IC, thereby connecting circuit components of the IC into a functioning whole and to the outside world. Because there typically is not enough room on the chip surface to create all of the necessary connections in a single layer, chip manufacturers build vertical levels of interconnect structures. While simpler ICs can have just a few metallization layers, complex ICs can have ten or more layers of interconnect structures.

BEOL-stage interconnect structures that are physically close to FEOL-stage components (e.g., transistors and the like) need to be small because they attach/join to the components that are themselves very small and often closely packed together. These lower-level lines, which can be referred to as local interconnects, are usually thin and short in length. Global interconnects are higher up in the IC layer structure and travel between different blocks of the circuit. Thus, global interconnects are typically thicker, longer, and more widely separated than local interconnects. Vertical connections between interconnect levels (or layers) are known as metal-filled vias and allow signals and power to be transmitted from one layer to the next. For example, a through-silicon via (TSV) is a conductive contact that passes completely through a given semiconductor wafer or die. In multi-layer IC configurations, for example, a TSV can be used to form vertical interconnections between a semiconductor device located on one layer/level of the IC and an interconnect layer located on another layer/level of the IC.

As previously noted herein, CAD/CAM software can be used to generate the IC layout that places and connects all of the components that make up each IC chip such that it meets certain criteria, including, for example, performance, size, density, and manufacturability. CAD/CAM software assists with so-called “place and route” IC design stages that map out the placement of electronic components/circuitry, along with the routing of interconnect structures needed to connect the placed components/circuitry. IC fabrication processes include the use of patterned masks to define and form the various devices (e.g., transistors) and interconnect structures of the IC design. The generated layout must pass a series of checks in a process known as physical verification. When all verification is complete, layout post processing is applied where the IC layout is translated into data (e.g., an industry-standard format, typically GDSII) and sent to a semiconductor foundry. The foundry converts the data into mask data and uses it to generate the masks used in a photolithographic process of semiconductor device fabrication.

However, as the size of IC structures continues to shrink, there are difficulties associated with maintaining the fidelity of IC structures at such small sizes. For example, when fabricating a rectangular-shaped elongated interconnect structure, it can be difficult to maintain a substantially consistent width dimension throughout the length of the interconnect structure. In some situations, various effects (e.g., proximity effects, edge effects, and the like) can cause an interconnect structure designed to have a rectangular shape to, during fabrication, substantially maintain the fidelity of the designed width dimension throughout a central region of the interconnect structure, but substantially lose the fidelity of the designed width dimension at one or more ends of the fabricated interconnect structure. This loss of width dimension fidelity manifest as a bulging of the interconnect structure at one or more of its end regions, and, where both end regions bulge, this can result in fabricated interconnect structures having dumbbell shaped profiles. This is highly undesirable and increases the likelihood of unwanted contact (or pinching off) between adjacent interconnect structures.

Turning now to an overview of aspects of the invention, embodiments of the invention provide programmable computers, computer-implemented methods, and computer program products operable to apply a bulging prediction analysis that predicts the interconnect structures of an IC design that will experience end-region bulging; determine the metes and bounds of one or more selective cut regions that define parameters of a removal or cut operation that removes the predicted bulging interconnect end-region(s) without removing or cutting interconnect structures that are not predicted to experience end-region bulging; and update a CAD file associated with the IC design to include the selective cuts that remove the predicted bulging end-regions without interfering with interconnect structures that are not predicted to experience end-region bulging during fabrication. In addition to predicting the interconnect structures of the IC design that will experience end-region bulging, embodiments of invention can also compute an “added length” for the interconnect structures that are predicted to experience end-region bulging. The “added length” increases the designed length of the interconnect structure by an amount that compensates for the cut bulging end-region(s) such that the post-cut interconnect structure will have the dimensions required by the IC design. This “added length” computations can be included among the updates provided to the CAD file associated with the IC design. The programmable computer systems, computer-implemented methods, and computer program products operable to predict the interconnect structures of an IC design that will experience end-region bulging (and the “added length” computations), configure and design selective cuts to selectively remove the predicted end-region bulging, and update a CAD file of the IC design to incorporate the predicted cuts (and the “added length” computations) can be implemented using CAD/CAM software programmed to perform the various operations of embodiments of the invention. The updated CAD file is used to control a semiconductor fabrication system to fabricate an IC according to the updated CAD file.

In some embodiments of the invention, the prediction of the interconnect structures of the IC design that will experience end-region bulging is made by determining a bulging predictor condition (BPC) of the IC DESIGN that is associated with the interconnect structure. In general, the BPC is one or more characteristics of the IC design that embodiments of the invention have determined are predictive of an interconnect structure experiencing end-region bulging during fabrication.

In some embodiments of the invention, the BPC is and/or includes the interconnect pattern density (IPD) of the IC design within a predetermined region around the interconnect structure. In general, IPD is the fractional area of a wafer layer's surface that is occupied by interconnect structures within a give window size. Inventors of embodiments of the invention have discovered that, where the IPD within a predetermined region around an interconnect structure is greater than a predetermined threshold (Thr) or within a predetermined range, this level of IPD is predictive of the associated interconnect structure not experiencing a meaningful level of end-region bulging (e.g., bulging that exceeds a bulging level threshold) during fabrication thereof. Inventors of embodiments of the invention have further discovered that, where the IPD within a predetermined region around an interconnect line is less than or equal to a predetermined threshold (Thr) or within another predetermined range, this level of IPD is predictive of the associated interconnect structure experiencing a meaningful level of bulging (e.g., bulging that exceeds a bulging level threshold) during fabrication thereof.

In some embodiments of the invention, the particular type of BPC (e.g., IPD) that is utilized to predict the location(s) of as-fabricated bulging is determined a priori and not derived from a specific analysis of the design of the to-be-fabricated IC. In some embodiments of the invention, the particular type of BPC that is used to predict the location(s) of as-fabricated bulging is determined non-a-priori based on an analysis of the design of the to-be-fabricated IC. In some embodiments of the invention, the CAD/CAM software used to implement aspects of the invention can include machine learning algorithms trained to evaluate the design of the to-be-fabricated IC to identify one or more types of BPCs of the IC design that are predictive of end-region bulging. In embodiments of the invention, any combination of a priori BPC determinations and non-a-priori BPC determinations can be used to predict the location(s) of as-fabricated bulging.

In embodiments of the invention, the term interconnect structure includes the final interconnect structure (e.g., a conductive metal line) as well as a variety interconnect-related structures, including, for example, initial, intermediate, and/or sacrificial structures used in the process that fabricates the final interconnect structure, particularly where the initial, intermediate, and/or sacrificial structures act as a form of template that defines the size shape, and/or location of the final interconnect structures. Bulging defects in such initial, intermediate, and/or sacrificial structures will be passed through the fabrication operations to the final interconnect structure. For example, in IC designs that use self-aligned litho-etch litho-etch (SALELE) interconnect fabrication operations, the interconnect structure includes the various initial, intermediate and sacrificial structures used to fabricate the final interconnect that will conduct current in the as-fabricated IC. For example, a so-called mandrel element is an interconnect structure used early in the SALELE process to define part of the template or templates used in SALELE processes to form the final interconnect structure. A bulge defect in the as-fabricated mandrel will propagate through the subsequent SALELE fabrication operations to cause a corresponding defect in the as-fabricated final interconnect structure. Accordingly, embodiments of the invention can be applied to mandrel interconnect structure to predict the mandrel interconnect structures of an IC design that will experience end-region bulging; determine the metes and bounds of one or more selective cut regions that define parameters of a removal or cut operation that removes the predicted bulging mandrel interconnect end-region(s) without removing or cutting interconnect structures that are not predicted to experience end-region bulging; and update a CAD file associated with the IC design to include the selective cuts that remove the predicted bulging end-regions without interfering with interconnect structures that are not predicted to experience end-region bulging during fabrication.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

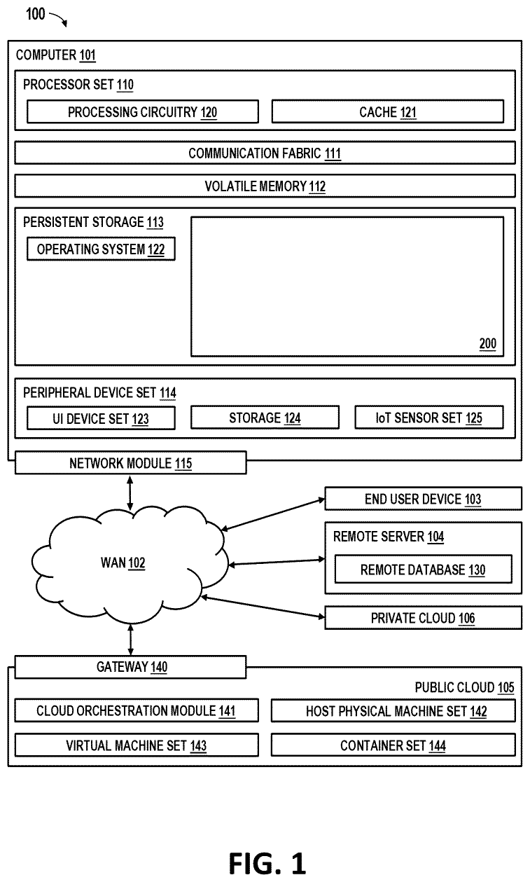

FIG. 1 depicts a computing environment 100 that contains an example of an environment for the execution of at least some of the computer code involved in performing the inventive methods, such as code block 200 operable to predict interconnect structures of an IC design that will experience end-region bulging and updating a CAD file of the IC design to include fabrication operations that selectively remove only the end-regions that are predicted to experience bulging. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

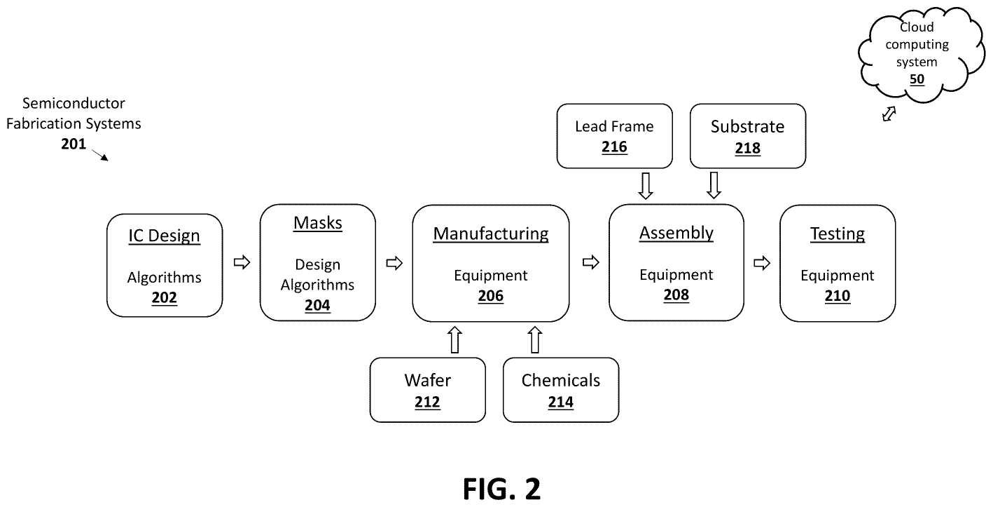

FIG. 2 depicts a block diagram illustrating semiconductor fabrication systems 201 that supports semiconductor fabrication processes capable of incorporating aspects of the invention. The various components of the semiconductor fabrication system 201 utilize various types of computing resources, which can be implemented as one or more aspects of the computing environment 100 (shown in FIG. 1). The semiconductor fabrication system 201 includes IC design support algorithms 202, mask design support algorithms 204, manufacturing support equipment 206, assembly support equipment 208, and testing support equipment 210, configured and arranged as shown. The IC design support algorithms 202 are configured and arranged to provide CAD assistance with the design of the logic circuits (AND, OR, and NOR gates) that form the various logic components of the IC, as well as the design of various interconnect structures used to form the signal communications network of the IC. Similarly, the mask design support algorithms 204 are configured and arranged to provide CAD assistance with generating the mask design, which is the representation of an IC in terms of planar geometric shapes that correspond to the patterns of metal, oxide, or semiconductor layers that make up the components and interconnect structures of the IC. The mask design places and connects the components and the interconnect structures that make up the IC such that they meet certain criteria, such as performance, size, density, and manufacturability.

The manufacturing equipment 206 is the equipment used in executing the FEOL, MOL, BEOL, and Far-BEOL processes (including singulation processes) used to form the finished wafers and IC chips (or semiconductor die). In general, the wafer manufacturing equipment 206 comes in various forms, most of which specialize in growing, depositing or removing materials from a wafer. Examples of wafer manufacturing equipment 206 include oxidation systems, epitaxial reactors, diffusion systems, ion implantation equipment, physical vapor deposition systems, chemical vapor deposition systems, photolithography equipment, etching equipment, polishing equipment and the like. The various types of manufacturing equipment 206 take turns in depositing and removing (e.g., using the chemicals 214) different materials on and from the wafer 212 in specific patterns until a circuit is completely built on the wafer 212. The assembly equipment 208 is used to package the IC chips into finished IC packages that are physically ready for use in customer applications. The assembly equipment 208 can include wafer back-grind systems, wafer saw equipment, die attach machines, wire-bonders, die overcoat systems, molding equipment, hermetic sealing equipment, metal can welders, DTFS (de-flash, trim, form, and singulation) machines, branding equipment, and lead finish equipment. The major components used by the assembly equipment 208 include but are not limited to lead frames 216 and substrates 218. The test equipment 210 is used to test the IC packages so that only known good devices will be shipped to customers. Test equipment 210 can include automatic test equipment (ATE); test handlers; tape and reel equipment; marking equipment; burn-in ovens; retention bake ovens; UV (ultraviolet) erase equipment, and vacuum sealers.

A cloud computing system 50 is in wired or wireless electronic communication with the system 201, and in particular with the computer-controlled elements of the system 201. The cloud computing system 50 can supplement, support or replace some or all of the computer functionality (in any combination) of the system 201. Additionally, some or all of the computer functionality of the system 201 can be implemented as a node of the cloud computing system 50. Additional details of cloud computing functionality that can be used in connection with aspects of the invention are depicted by the computing environment 100 shown in FIG. 1 and described previously herein.

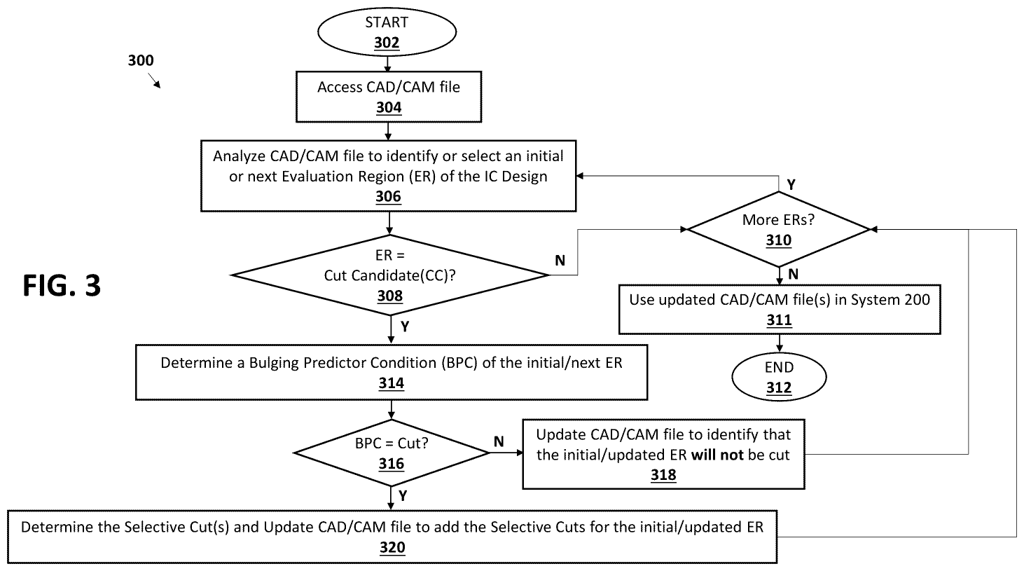

FIG. 3 depicts a flow diagram illustrating a computer-implemented methodology 300 that can be implemented using the semiconductor fabrication system 201 (shown in FIG. 2) in general, and more specifically, using the IC design support algorithms 202, the mask design support algorithms 204, and the manufacturing support equipment 206 of the semiconductor fabrication system 201, all in accordance with embodiments of the invention. The computer-implemented methodology 300 will now be described with reference, where appropriate, to the corresponding component of the IC design support algorithms 202, the mask design support algorithms 204, and the manufacturing support equipment 206 shown in FIG. 2, along with the methodology 300 shown in FIG. 3.

The methodology 300, in accordance with embodiments of the invention, can be applied to interconnect structures of an IC design, as well as to subsequent fabrication operations according to the IC design. In embodiments of the invention, the term interconnect structure includes the final interconnect structure (e.g., a conductive metal line) as well as a variety interconnect-related structures, including, for example, initial, intermediate, and/or sacrificial structures used in the process that fabricates the final interconnect structure, particularly where the initial, intermediate, and/or sacrificial structures act as a form of template that define or determine the size shape, and/or location of the final interconnect structures. Bulging defects in such initial, intermediate, and/or sacrificial template-like interconnect structures will be passed through the fabrication operations to the final interconnect structure. For example, in IC designs that use SALELE interconnect fabrication operations, the interconnect structure includes the various initial, intermediate, and/or sacrificial structures used to fabricate the final interconnect that will conduct current in the as-fabricated IC. For example, a so-called mandrel element is an interconnect structure used early in the SALELE process to define part of the template or templates used in SALELE processes to form the final interconnect structure. A bulge defect in the as-fabricated mandrel will propagate through the subsequent SALELE fabrication operations to cause a corresponding defect in the as-fabricated final interconnect structure. Accordingly, the methodology 300, in accordance with embodiments of the invention, can be applied to mandrel interconnect structure to predict the mandrel interconnect structures of an IC design that will experience end-region bulging; determine the metes and bounds of one or more selective cut regions that define parameters of a removal or cut operation that removes the predicted bulging mandrel interconnect end-region(s) without removing or cutting interconnect structures that are not predicted to experience end-region bulging; and update a CAD file associated with the IC design to include the selective cuts that remove the predicted bulging end-regions without interfering with interconnect structures that are not predicted to experience end-region bulging during fabrication

The methodology 300 starts at block 302 then moves to block 304 where a CAD file associated with an IC design and/or a CAM file associated with the IC design are accessed using CAD software functionality and/or CAM software functionality of the IC design support algorithms 202. In embodiments of the invention, the accessed CAD file and/or CAM file represent electronically the details of an IC design that will be fabricated using the semiconductor fabrication system 201. At block 306, the IC design algorithms 202 include functionality that segments the IC design into evaluation regions (ERs) and identifies or selects an initial or next ER that will be evaluated or analyzed using aspects of the invention. At decision block 308, the methodology 300 determines whether or not the selected/next ER is a cut candidate (CC). CCs can be determined based on a suitable standard for making an initial course grain evaluation of whether a bulging prediction analysis (e.g., blocks 312-318) should applied to the ER. For example, in some embodiments of the invention, the CCs can be identified based on whether or not the initial/next ER includes any type interconnect structure at all during the fabrication process. If no interconnect structures will be formed in the initial/next ER, the initial/next ER can be classified as not a CC. If one or more interconnect structures will be formed in the initial/next ER, the initial/next ER can be classified as a CC. As another example, in some embodiments of the invention, if one or more interconnect structures will be formed in the initial/next ER, the initial/next ER can be further evaluated based at least in part on whether or not the interconnect structure in the initial/next ER are known to experience bulging issues. In some embodiment of the invention, the interconnect structures that are known to experience bulging issues include the interconnect structures used in a self-aligned litho-etch litho-etch (SALELE) of the IC design. If the interconnect structures that will be formed in the initial/next ER are not known to experience bulging, the interconnect structures in the initial/next ER can be classified as not a CC. If the interconnect structures that will be formed in the initial/next ER are known to experience bulging (e.g., they are fabricated using SALELE), the interconnect structures in the initial/next ER can be classified as a CC.

If the answer to the inquiry at decision block 308 is no, the methodology 300 moves to decision block 310 to determine whether or not there are additional ERs in the IC design CAD/CAM files that need to be evaluated by the methodology 300. If the answer to the inquiry at decision block 310 is yes, the methodology 300 moves to block 306 to identify or select a next ER of the IC design. If the answer to the inquiry at decision block 310 is no, the methodology 300 moves to block 3110 and uses the updated CAD/CAM files in the semiconductor fabrication system 100 to fabricate the IC design updated to include the bulging end-region removal operations and/or “additional length” operations identified by the methodology 300. From block 311, the methodology 300 moves to block 312 and ends.

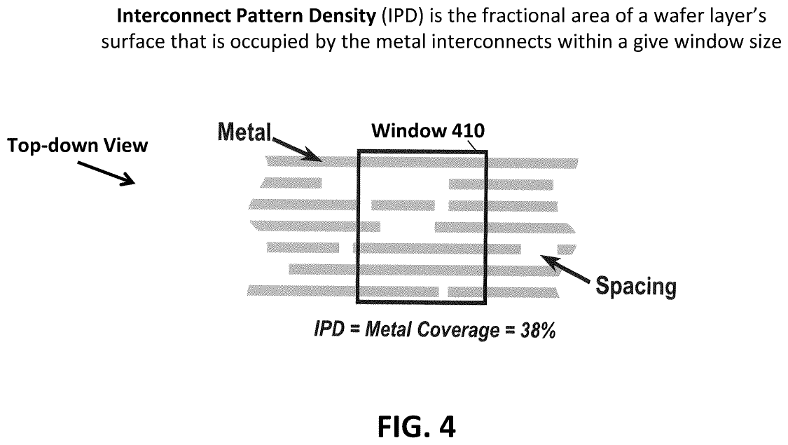

If the answer to the inquiry at decision block 308 is yes, the methodology 300 moves to block 314 to determine a BPC of the initial/next ER. In general, the BPC is one or more characteristics of the IC design that embodiments of the invention have determined are predictive of an interconnect structure in the IC design experiencing end-region bulging during fabrication. In some embodiments of the invention, the BPC is and/or includes the interconnect pattern density (IPD) within the initial/updated ER of the IC design and/or within a predetermined region around each of the interconnect structures of the initial/updated ER of the IC design. FIG. 4 depicts a top-down view of an IC wafer surface that illustrates the concept of IPD. As illustrated by FIG. 4, the IPD of a wafer surface can be captured as the fractional area of the layer surface that is occupied by the metal interconnects within a given window size (e.g., window 408 shown in FIG. 4). Inventors of embodiments of the invention have discovered that, where the IPD within a predetermined region around an interconnect structure is greater than a predetermined threshold (Thr) or within a predetermined range, this level of IPD is predictive of the associated interconnect structure not experiencing a meaningful level of end-region bulging (e.g., bulging that exceeds a bulging level threshold) during fabrication thereof. Inventors of embodiments of the invention have further discovered that, where the IPD within a predetermined region around an interconnect line is less than or equal to a predetermined threshold (Thr) or within another predetermined range, this level of IPD is predictive of the associated interconnect structure experiencing a meaningful level of bulging (e.g., bulging that exceeds a bulging level threshold) during fabrication thereof.

In some embodiments of the invention, the particular type of BPC (e.g., IPD) that is utilized at decision block 316 to predict the location(s) of as-fabricated bulging is determined a priori and not derived from a specific analysis of the design of the to-be-fabricated IC. In some embodiments of the invention, the particular type of BPC that is used at decision block 316 to predict the location(s) of as-fabricated bulging is determined non-a-priori based on an analysis of the design of the to-be-fabricated IC. In some embodiments of the invention, the CAD/CAM software used to implement the decision at decision block 316 in accordance with aspects of the invention can include machine learning algorithms trained to evaluate the design of the to-be-fabricated IC to identify one or more types of BPCs of the IC design that are predictive of end-region bulging. In embodiments of the invention, any combination of a priori BPC determinations and non-a-priori BPC determinations can be used at decision block 316 to predict the location(s) of as-fabricated interconnect bulging.

In embodiments of the invention, in addition to determining whether the BPC indicates the need for a cut to remove interconnect bulging, the decision at decision block 316 can further include, for interconnect structures that require a cut, computing an “added length” for the interconnect structures that are predicted to experience end-region bulging. The “added length” increases the designed length of the interconnect structure by an amount that compensates for the cut bulging end-region(s) such that the post-cut interconnect structure will have the dimensions required by the IC design.

This “added length” computations can be included among the updates provided to the CAD file associated with the IC design. The programmable computer systems, computer-implemented methods, and computer program products operable to predict the interconnect structures of an IC design that will experience end-region bulging (and the “added length” computations), configure and design selective cuts to selectively remove the predicted end-region bulging, and update a CAD file of the IC design to incorporate the predicted cuts (and the “added length” computations) can be implemented using CAD/CAM software programmed to perform the various operations of embodiments of the invention. The updated CAD file is used to control a semiconductor fabrication system to fabricate an IC according to the updated CAD file.

If the answer to the inquiry at decision block 316 is no, the methodology 300 moves to block 316 where the IC design support algorithms 202 and/or the mask design support algorithms 204 use the no (or no cut) determination at decision block 316 to update the CAD/CAM file of the IC design to identify that the initial/updated ER will not be changed to include a bulge-related cut. In some embodiments of the invention, the operations at block 318 can be skipped if it is determined that computational resources should not be devoted to recording and tracking the ERs in the IC design that are not being changed by the methodology 300 to include end-region bulging cuts. From block 318 (or from a “no” determination at decision block 316 if block 318 is not used), the methodology 300 moves to decision block 310 to determine whether or not there are additional ERs in the IC design CAD/CAM files that need to be evaluated by the methodology 300. If the answer to the inquiry at decision block 310 is yes, the methodology 300 moves to block 306 to identify or select a next ER of the IC design. If the answer to the inquiry at decision block 310 is no, the methodology 300 moves to block 3110 and uses the updated CAD/CAM files in the semiconductor fabrication system 100 to fabricate the IC design updated to include the bulging end-region removal operations and/or “additional length” operations identified by the methodology 300. From block 311, the methodology 300 moves to block 312 and ends.

If the answer to the inquiry at decision block 316 is yes, the methodology 300 moves to block 320 where the IC design support algorithms 202 and/or the mask design support algorithms 204 use the cut-needed determination at decision block 316 to update the CAD/CAM file of the IC design to identify that the initial/updated ER will be changed to include bulge-related cuts, along with the “added length” computations associated with the bulge-related cuts. From block 320, the methodology 300 moves to decision block 310 to determine whether or not there are additional ERs in the IC design CAD/CAM files that need to be evaluated by the methodology 300. If the answer to the inquiry at decision block 310 is yes, the methodology 300 moves to block 306 to identify or select a next ER of the IC design. If the answer to the inquiry at decision block 310 is no, the methodology 300 moves to block 3110 and uses the updated CAD/CAM files in the semiconductor fabrication system 100 to fabricate the IC design updated to include the bulging end-region removal operations and/or “additional length” operations identified by the methodology 300. From block 311, the methodology 300 moves to block 312 and ends.

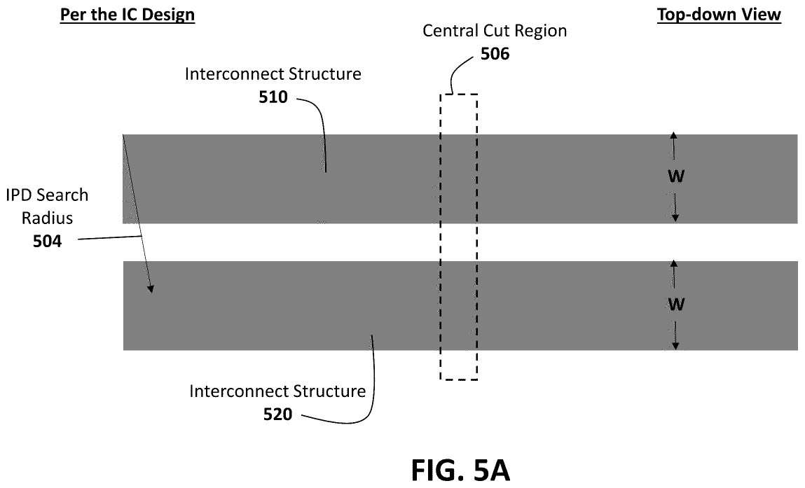

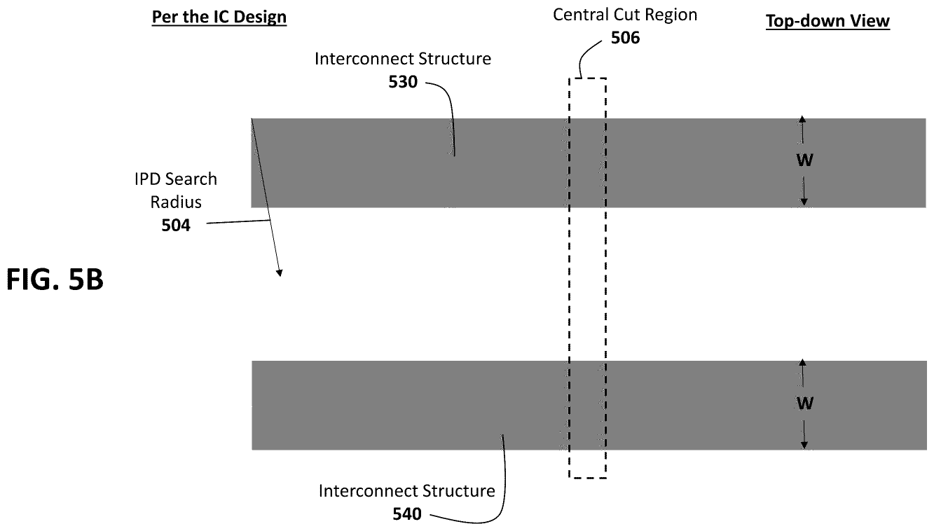

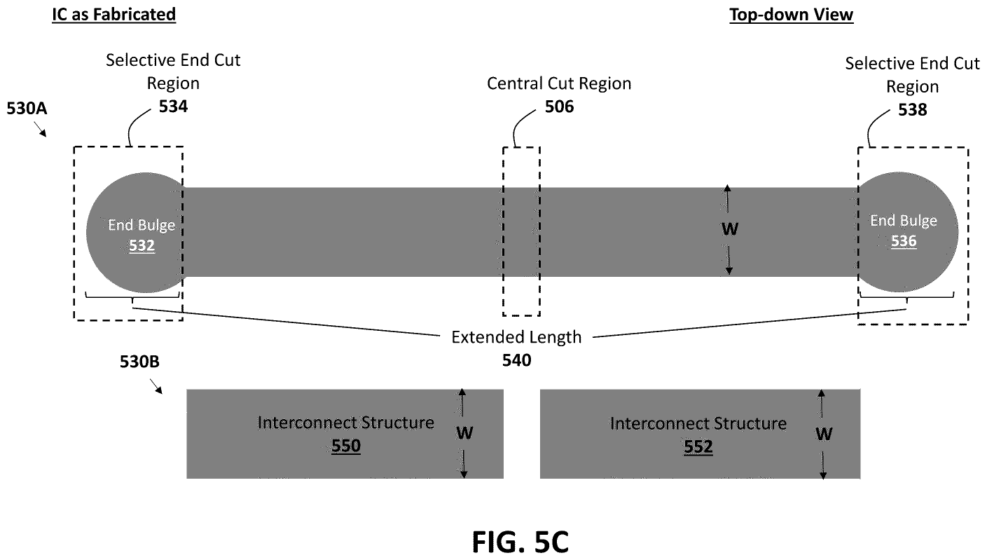

FIGS. 5A-5C depict simplified block diagrams illustrating non-limiting examples of the bulging-related predictions and CAD/CAM updates generated by the computer-implemented methodology 300 (shown in FIG. 3). More specifically, FIG. 5A depicts a simplified block diagram illustrating a top-down view of as-designed interconnect structures 510, 520 that are being evaluated using the methodology 300 (particularly, blocks 314, 316 of the methodology 300) to generate a BPC associated with the interconnect structures 510, 520. In the example depicted in FIG. 5A, the interconnect structures 510, 520 are designed, per the associated IC design, to provide a substantially consistent width dimension (W) across the horizontal length of each of the interconnect structures 510, 520. The original IC design includes a cut region 506 that, when implemented during fabrication, divides each interconnect structure 510, 520 into left and right sections. In the example depicted in FIG. 5A, the BPC being applied is IPD, and the method of evaluating IPD to make the determination at decision block 316 is whether or not another interconnect structure is within a predetermined distance from the end regions of the interconnect structures 510, 520. The predetermined distance is represented in FIG. 5A by an IPD search radius 504, which is attached (through CAD operations) to various points along the end-regions of the interconnect structures 510, 520 that are susceptible to experiencing bulging during fabrication, and then rotated to define an IPD search area in which the IPD level is computed. In embodiments of the invention, an IPD threshold is set such that an IPD level of above zero (0) for any point on the end-region results in a determination at block 316 that BPC≠Cut, which leads from decision block 316 to block 318 in the methodology 300. Additionally, an IPD level at zero (0) for any point on the end-region results in a determination at block 316 that BPC=Cut, which leads from decision block 316 to block 320 in the methodology 300. In the example depicted in FIG. 5A, the IPD level in the IPD search area defined by the IPD search radius 504 is above zero (0), which means that the interconnect structure 510 is predicted to not experience end region bulging and will not need a selective cut. In the example depicted in FIG. 5A, substantially the same results are obtained from applying the IPD search radius 504 to the other end-region of the interconnect structure 510, as well as both end-regions of the neighboring interconnect structure 520. The IPD search radius 504 can be any suitable number that aligns with the particular IC design. In some embodiments of the invention, the IPD search radius 504 is about 200 nm.

FIG. 5B depicts a simplified block diagram illustrating a top-down view of as-designed interconnect structures 530, 540 that are being evaluated using the methodology 300 (particularly, blocks 314, 316 of the methodology 300) to generate a BPC associated with the interconnect structures 530, 540. The example depicted in FIG. 5B is substantially the same as the example depicted in FIG. 5A, except that, for the example depicted in FIG. 5B, the IPD level in the IPD search region is at zero (0), which means that the interconnect structure 530 is predicted to experience end-region bulging and will need a selective cut to remove the end-region bulge. In the example depicted in FIG. 5B, substantially the same results are obtained from applying the IPD search radius 504 to the other end-region of the interconnect structure 530, as well as both end-regions of the neighboring interconnect structure 540. The IPD search radius 504 can be any suitable number that aligns with the particular IC design. In some embodiments of the invention, the IPD search radius 504 is about 200 nm.

FIG. 5C depicts a simplified block diagram illustrating a top-down view of an interconnect structure 530A, which is the as-fabricated version of the interconnect structure 530 (shown in FIG. 5B) that has been classified as needing a selective cut in accordance with aspects of the invention. Because the as-fabricated interconnect structure 530A was predicted to generate the end bulge regions 532, 536, extended length 540 was added to the as-fabricated interconnect structure 530A in accordance with aspects of the invention to compensate for the end bulge regions 532, 536 after they are removed. In accordance with embodiments of the invention, the selective end cut regions 534, 538 are computed to remove regions that were predicted to experience bulging without interfering with interconnect structures that are not predicted to experience bulging. FIG. 5C also depicts a top-down view of an as-fabricated interconnect structure 530B, which is the as-fabricated interconnect structure 530A after the selective end cut regions 534, 538 and the central cut region 506 have been removed in accordance with embodiments of the invention, which results in the post-cut, as-fabricated interconnect region 530B having interconnect structure 550 and interconnect structure 552 both of which have the substantially consistent width dimension W provided by the IC design.

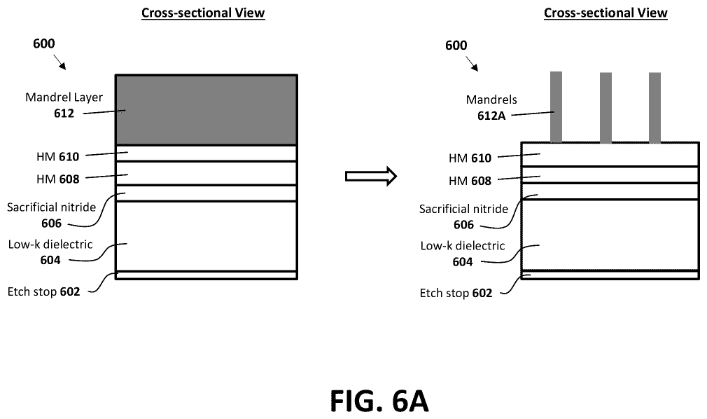

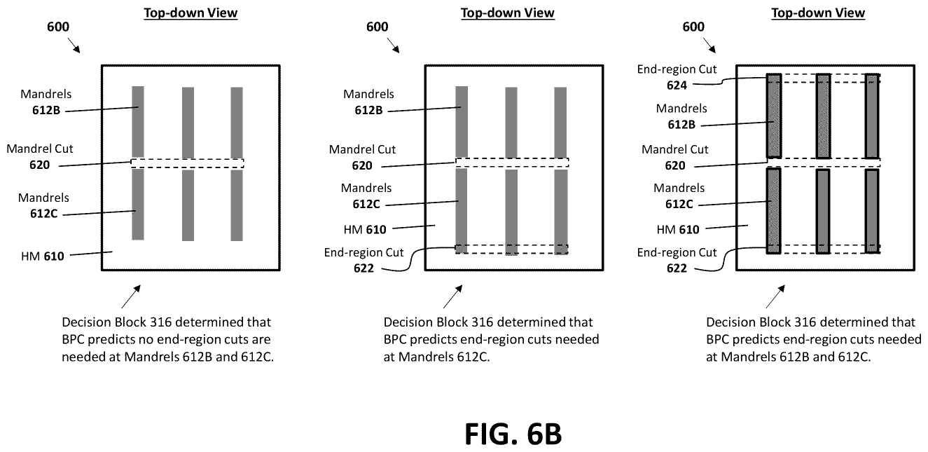

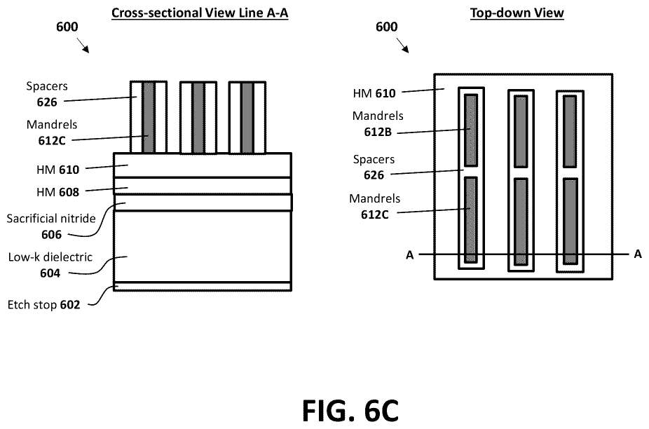

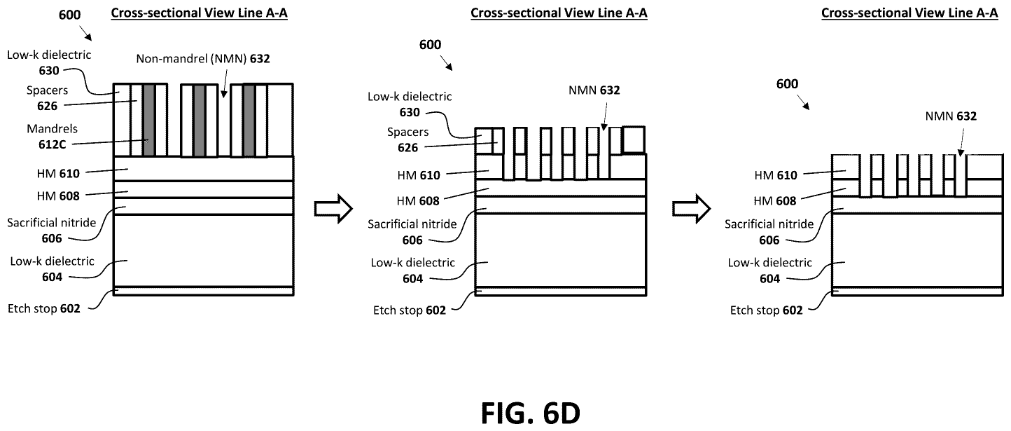

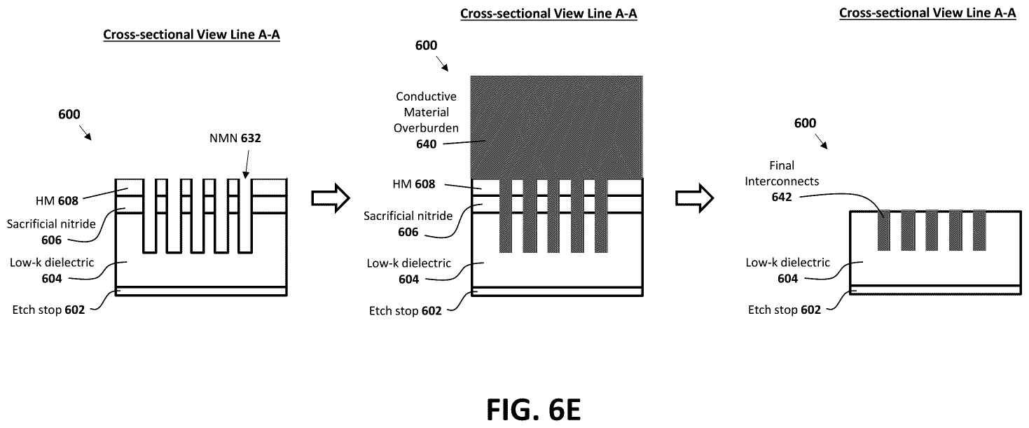

Embodiments of the invention can be used to address unwanted end-region bulging in one or more interconnects structures used in SALELE interconnect fabrication processes. In embodiments of the invention, the one or more interconnect structures can include the mandrel elements used in SALELE interconnect fabrication processes. FIGS. 6A-6E depict cross-sectional views and/or top-down views illustrating a portion of a multi-layer IC 600 after SALELE fabrication operations in accordance with aspects of the invention. The fabrication begins by performing a variety of known semiconductor fabrication operations to form the portion of the multi-layer IC 600 shown in the leftmost image in FIG. 6A. In embodiments of the invention, the portion of the multi-layer IC 600 in FIG. 6A is in a BEOL region of the multi-layer IC having additional BEOL layers, MOL layer, FEOL layers and a substrate positioned below. After the known fabrication operations, the leftmost image of FIG. 6A includes an etch stop layer 602, a low-k dielectric layer 604, a sacrificial nitride layer 606, a hard mask (HM) layer 608, a HM layer 610, and a mandrel material layer 612, configured and arranged as shown. In some embodiments of the invention, non-limiting example materials and dimensions for the layers 602-612 include about 8 nm of SiCN for the etch stop layer 602; about 60 nm of SiCNO for the low-k dielectric layer 604; about 20 nm of nitride material for the sacrificial nitride layer 606, about 20 nm of TiN for the hard mask (HM) layer 608; about 10 nm of TEOS for the HM layer 610; and about 45 nm of SiN for the mandrel material layer 612.

In the rightmost image of FIG. 6A, known semiconductor fabrication operations have been used to pattern and etch the mandrel material 612, thereby forming elongated fin-shaped mandrels 612A. The top-down view of the mandrels 612A is similar to the top-down view of the mandrels 510, 520 shown in FIG. 5A.

FIG. 6B depicts a leftmost image, a central image and a rightmost image illustrating top-down views of the portion of the cuts that will be applied to the multi-layer IC 600 under 3 different example scenarios. For all the images the mandrel cut 620 is applied to form mandrels 612B and mandrels 612C. The mandrel cut 620 corresponds to the central cut region 506 shown in FIGS. 5A-5C. The leftmost image represents the scenario in which decision block 316 of the methodology 300 (shown in FIG. 3) determined that BPC predicts no end-region cuts are needed at mandrels 612B and 612C. The central image represents the scenario in which decision block 316 of the methodology 300 determined that BPC predicts an end-region cut 622 is needed at mandrel 612C but no end-region cut is needed at mandrel 612B. The rightmost image represents the scenario in which decision block 316 of the methodology 300 determined that BPC predicts that end-region cuts 622, 624 are needed at mandrels 612C and 612B, respectively. Note that for the mandrel cuts in the central image and the rightmost image of FIG. 6B, the extended length 540 (shown in FIG. 5C) has been added to compensate for the interconnect portions removed by the end-region cuts 622, 624. For ease of illustration and description, the end bulges are not shown in the central and rightmost images of FIG. 6B, however it is understood that the end bulges corresponding to the end bulges 532, 534 shown in FIG. 5C are present for the end regions where as-fabricated end-region bulging if predicted.

FIG. 6C depicts a cross-sectional view (taken along line A-A of the top-down view) and a top-down view of the portion of the multi-layer IC 600 after known semiconductor fabrication operations have been used to conformally deposit a layer of spacer material over the portion of the multi-layer IC 600, then directionally etched to expose the top surfaces of the mandrels 612B, 612C, as well as portion of the top surface of the HM layer 610, thereby forming spacers 626 on sidewalls of the mandrels 612B, 612C.

FIG. 6D depicts cross-sectional views (taken along line A-A of the top-down view in FIG. 6C) of the portion of the multi-layer IC 600 after fabrication operations according to aspects of the invention. In the leftmost image of FIG. 6D, an additional low-k dielectric layer 630 has been conformally deposited, planarized, and selectively etched (e.g., through patterning) to form the non-mandrel (NMN) regions 632. In the central image, the portion of the multi-layer IC 600 has been further planarized, the mandrels 612B, 612C have been removed to form additional NMN regions 632, and the exposed portions of the HM 610 have been etched such that the NMN regions 632 extend deeper into the HM 610, stopping on the HM 608. In the rightmost image, the portion of the multi-layer IC 600 has been further planarized to remove the low-k dielectric layer 630 and the spacers 626, and the exposed portions of the HM 608 have been etched such that the NMN regions 632 extend deeper into the HM 608, stopping on the sacrificial nitride layer 606.

FIG. 6E depicts cross-sectional views (taken along line A-A of the top-down view in FIG. 6C) of the portion of the multi-layer IC 600 after fabrication operations according to aspects of the invention. In the leftmost image of FIG. 6E, the portion of the multi-layer IC 600 has been further planarized to remove the HM 610, and has been further etched such that NMN regions 632 extend through the sacrificial nitride layer 606 and into the low-k dielectric layer 604. deeper into the HM 610, stopping on the HM 608. In the central image, a conductive material overburden 640 is deposited over the portion of the multi-layer IC 600 and planarized. In the rightmost image, the portion of the multi-layer IC 600 has been further planarized to remove the remaining portion of the HM 608 and the remaining portion of the sacrificial nitride layer 606 to thereby form the final interconnects 642. In accordance with embodiments of the non-bulging mandrels 612B, 612C has permeated through the SALELE operations depicted in FIGS. 6B-6E such that the final interconnects 642 also do not have bulging end-regions.

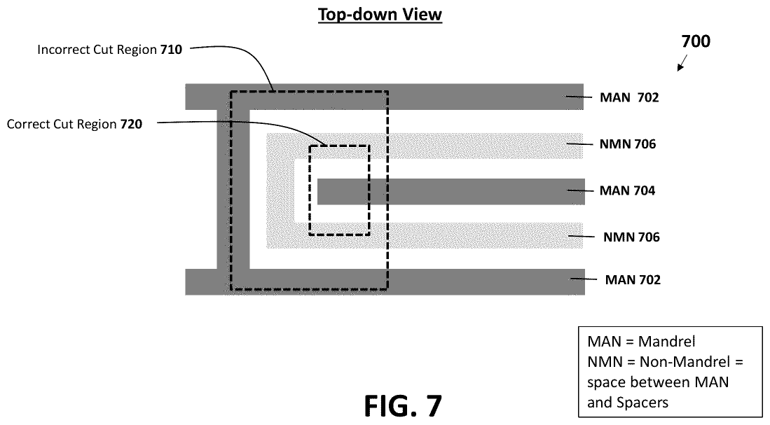

FIG. 7 depicts a top-down view of a portion of a multi-layer IC 700 illustrating an incorrect cut region 710, which is avoided by embodiments of the invention, along with a correct cut-region 720, which is generated according to aspects of the invention. As shown, the portion of a multi-layer IC 700 includes a mandrel region 702, a NMN region 706, and mandrel region 704, configured and arranged as shown. Where the methodology 300 (shown in FIG. 3) predicts that an inside end-region of the mandrel 704 will experience bulging, the methodology 300 draws the cut region 720 selectively such that the bulging in the inside end-region the mandrel 704 will be removed without interfering with the nearby mandrel 702. While the incorrect cut region 710 would remove bulging in the inside end-region the mandrel 704, embodiments of the invention would not draw the incorrect cut region 710 because the incorrect cut region 710 it would interfere with (e.g., at least partially remove) the mandrel 702 in areas that do not need to be cut (per the IC design).

Embodiments of the invention that utilize machine learning techniques, including, for example, determining a BPC of the IC design per block 314 of the methodology 300 shown in FIG. 3. In embodiments of the invention, the machine learning techniques incorporated in the IC design algorithms 202 and/or the mask design algorithms 204 for performing aspects of the invention can include a machine learning or classifier system. More specifically, the functionality of the system is used in embodiments of the invention to generate various models and sub-models that can be used to implement computer functionality in embodiments of the invention. The machine learning classifier system includes multiple data sources in communication through a network with a classifier. In some aspects of the invention, the data sources can bypass the network and feed directly into the classifier. The data sources provide data/information inputs that will be evaluated by the classifier in accordance with embodiments of the invention. The data sources also provide data/information inputs that can be used by the classifier to train and/or update model(s) created by the classifier. The data sources can be implemented as a wide variety of data sources, including but not limited to, the relevant CAD/CAM files, data repositories (including training data repositories), and outputs from other classifiers. The network can be any type of communications network, including but not limited to local networks, wide area networks, private networks, the Internet, and the like.

The classifier can be implemented as algorithms executed by a programmable computer such as the computing environment 100 (shown in FIG. 1). The classifier can include a suite of machine learning (ML) algorithms; natural language processing (NLP) algorithms; and model(s) that are relationship (or prediction) algorithms generated (or learned) by the ML algorithms. The NLP and ML algorithms receive and evaluate input data (i.e., training data and data-under-analysis) from the data sources. The ML algorithms includes functionality that is necessary to interpret and utilize the input data's format. For example, where the data sources include image data, the ML algorithms can include visual recognition software configured to interpret image data. The ML algorithms apply machine learning techniques to received training data (e.g., data received from one or more of the data sources) in order to, over time, create/train/update one or more models that model the overall task and the sub-tasks that the classifier is designed to complete.

In its learning phase, the classifier extracts features from the training data and coverts the features to vector representations that can be recognized and analyzed by the ML algorithms. The features vectors are analyzed by the ML algorithm to “classify” the training data against the target model (or the model's task) and uncover relationships between and among the classified training data. Examples of suitable implementations of the ML algorithms include but are not limited to neural networks, support vector machines (SVMs), logistic regression, decision trees, hidden Markov Models (HMMs), and the like. The learning or training performed by the ML algorithms can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier and the ML algorithms. Unsupervised learning can utilize additional learning/training methods including, for example, clustering, anomaly detection, neural networks, deep learning, and the like.

When the models are sufficiently trained by the ML algorithms, the data sources that generate “real world” data are accessed, and the “real world” data is applied to the models to generate usable versions of classification results. In some embodiments of the invention, the classification results can be fed back to the classifier and used by the ML algorithms as additional training data for updating and/or refining the models.

As previously noted herein, for the sake of brevity, conventional techniques related to semiconductor device and integrated circuit (IC) fabrication may or may not be described in detail herein. By way of background, however, a more general description of the semiconductor device fabrication processes that can be utilized in implementing one or more embodiments of the present invention will now be provided. Although specific fabrication operations used in implementing one or more embodiments of the present invention can be individually known, the described combination of operations and/or resulting structures of the present invention are unique. Thus, the unique combination of the operations described in connection with the fabrication of a semiconductor device according to the present invention utilize a variety of individually known physical and chemical processes performed on a semiconductor (e.g., silicon) substrate, some of which are described in the immediately following paragraphs.

In general, the various processes used to form a micro-chip that will be packaged into an IC fall into four general categories, namely, film deposition, removal/etching, semiconductor doping and patterning/lithography. Deposition is any process that grows, coats, or otherwise transfers a material onto the wafer. Available technologies include physical vapor deposition (PVD), chemical vapor deposition (CVD), electrochemical deposition (ECD), molecular beam epitaxy (MBE) and more recently, atomic layer deposition (ALD) among others. Removal/etching is any process that removes material from the wafer. Examples include etch processes (either wet or dry), chemical-mechanical planarization (CMP), and the like. Reactive ion etching (RIE), for example, is a type of dry etching that uses chemically reactive plasma to remove a material, such as a masked pattern of semiconductor material, by exposing the material to a bombardment of ions that dislodge portions of the material from the exposed surface. The plasma is typically generated under low pressure (vacuum) by an electromagnetic field. Semiconductor doping is the modification of electrical properties by doping, for example, transistor sources and drains, generally by diffusion and/or by ion implantation. These doping processes are followed by furnace annealing or by rapid thermal annealing (RTA). Annealing serves to activate the implanted dopants. Films of both conductors (e.g., poly-silicon, aluminum, copper, etc.) and insulators (e.g., various forms of silicon dioxide, silicon nitride, etc.) are used to connect and isolate transistors and their components. Selective doping of various regions of the semiconductor substrate allows the conductivity of the substrate to be changed with the application of voltage. By creating structures of these various components, millions of transistors can be built and wired together to form the complex circuitry of a modern microelectronic device. Semiconductor lithography is the formation of three-dimensional relief images or patterns on the semiconductor substrate for subsequent transfer of the pattern to the substrate. In semiconductor lithography, the patterns are formed by a light sensitive polymer called a photo-resist. To build the complex structures that make up a transistor and the many wires that connect the millions of transistors of a circuit, lithography and etch pattern transfer steps are repeated multiple times. Each pattern being printed on the wafer is aligned to the previously formed patterns and slowly the conductors, insulators and selectively doped regions are built up to form the final device.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

“Planarization” and “planarize” as used herein refer to a material removal process that employs at least mechanical forces, such as frictional media, to produce a substantially two-dimensional surface. A planarization process may include chemical mechanical polishing (CMP) or grinding. CMP is a material removal process that uses both chemical reactions and mechanical forces to remove material and planarize a surface.

The phrase “selective to,” such as, for example, “a first element selective to a second element,” means that the first element can be etched and the second element can act as an etch stop.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The term “conformal” (e.g., a conformal layer) means that the thickness of the layer is substantially the same on all surfaces, or that the thickness variation is less than 15% of the nominal thickness of the layer.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be understood that those skilled in the art, both now and in the future, may make various improvements and enhancements which fall within the scope of the claims which follow.

What is claimed is:

1. A computer system comprising a processor communicatively coupled to a memory, wherein the processor performs processor operations comprising:
accessing an electronic file comprising an electronic integrated circuit (IC) design;
wherein the electronic file is operable to control a fabrication system to fabricate an IC according to the electronic IC design;
applying a bulging predication analysis to the electronic IC design; and
making one or more changes to the electronic IC design based at least in part on a result of the bulging prediction analysis.

2. The computer system of claim 1, wherein the bulging prediction analysis is operable to predict that an interconnect structure of the electronic IC design will experience bulging during fabrication of the electronic IC design.

3. The computer system of claim 2, wherein the processor operations further comprising using one or more machine learning algorithms operable to predict that the interconnect structure of the electronic IC design will experience bulging during fabrication of the electronic IC design.

4. The computer system of claim 2, wherein the one more changes to the electronic IC design comprise adding to the electronic IC design a cut operation that removes a region of the interconnect structure that will experience bulging during the fabrication of the electronic IC design.

5. The computer system of claim 4, wherein parameters of the cut operation that removes the region of the interconnect structure that will experience bulging are selected such that the cut operation that removes the region of the interconnect structure that will experience bulging does not cut an interconnect structure that is not predicted by the bulging prediction analysis to experience bulging.

6. The computer system of claim 5, wherein the one more changes to the electronic IC design comprises increasing a size dimension of the interconnect structure that will experience bulging during the fabrication of the electronic IC design.

7. The computer system of claim 6, wherein increasing the size dimension of the interconnect structure that will experience bulging compensates for the cut operation that removes the region of the interconnect structure that will experience bulging.

8. The computer system of claim 1, wherein the bulging prediction analysis comprises determining a bulging prediction condition (BPC) associated with an interconnect structure of the electronic IC design.

9. The computer system of claim 8, wherein the BPC comprises interconnect pattern density.

10. A computer program product comprising a computer readable program stored on a computer readable storage medium, wherein the computer readable program, when executed on a processor system, causes the processor system to perform processor operations comprising:
accessing an electronic file comprising an electronic integrated circuit (IC) design;
wherein the electronic file is operable to control a fabrication system to fabricate an IC according to the electronic IC design;
applying a bulging predication analysis to the electronic IC design; and
making one or more changes to the electronic IC design based at least in part on a result of the bulging prediction analysis.

11. The computer program product of claim 10, wherein the bulging prediction analysis is operable to predict that an interconnect structure of the electronic IC design will experience bulging during fabrication of the electronic IC design.

12. The computer program product of claim 11, wherein the processor operations further comprising using one or more machine learning algorithms operable to predict that the interconnect structure of the electronic IC design will experience bulging during fabrication of the electronic IC design.

13. The computer program product of claim 11, wherein the one more changes to the electronic IC design comprises adding to the electronic IC design a cut operation that removes a region of the interconnect structure that will experience bulging during the fabrication of the electronic IC design.

14. The computer program product of claim 13, wherein parameters of the cut operation that removes the region of the interconnect structure that will experience bulging are selected such that the cut operation that removes the region of the interconnect structure that will experience bulging does not cut an interconnect structure that is not predicted by the bulging prediction analysis to experience bulging.

15. The computer program product of claim 14, wherein:
the one more changes to the electronic IC design comprises increasing a size dimension of the interconnect structure that will experience bulging during the fabrication of the electronic IC design; and
increasing the size dimension of the interconnect structure that will experience bulging compensates for the cut operation that removes the region of the interconnect structure that will experience bulging.

16. A multi-layer integrated circuit (IC) comprising:
a network of interconnect structures;
wherein the network of interconnect structures comprises:
one or more end-cut interconnect structures; and
one or more non-end-cut interconnect structures; and
wherein a bulging predictor condition (BPC) associated with each of the one or more end-cut interconnect structures is within a predetermined end-cut BPC range.

17. The multi-layer IC of claim 16, wherein a BPC associated with each of the one or more non-end-cut interconnect structures is within a predetermined non-end-cut BPC range.

18. The multi-layer IC of claim 17, wherein the BPC associated with each of the one or more end-cut interconnect structures comprises an interconnect pattern density (IPD) associated with each of the one or more end-cut interconnect structures.

19. The multi-layer IC of claim 18, wherein the BPC associated with each of the one or more non-end-cut interconnect structures comprises an interconnect pattern density (IPD) associated with each of the one or more non-end-cut interconnect structures.

20. The multi-layer IC of claim 18, wherein the network of interconnect structures comprises a network of back-end-of-line (BEOL) interconnect structures.
